(19) United States
(12) Patent Application Publication
(10) Pub. No.: US 2020/0045412 A1
(43) Pub. Date: Feb. 6, 2020

(54) SOUND DEVICE

(71) Applicant: AAC ACOUSTIC TECHNOLOGIES (SHENZHEN) CO., LTD., Shenzhen (CN)

(72) Inventors: Rongrong Wu, Shenzhen (CN); Chengxia Ji, Shenzhen (CN); Hui Chen, Shenzhen (CN); Zhaoxian Chen, Shenzhen (CN); Kejia Liu, Shenzhen (CN)

(21) Appl. No.: 16/524,176

(22) Filed: Jul. 29, 2019

(30) Foreign Application Priority Data
Aug. 1, 2018 (CN) 201821235845.9

(51) Int. Cl. H04R 1/28; H04R 9/06; H04R 1/02; H04R 9/02

(52) U.S. Cl. CPC H04R 1/2811; H04R 9/06; H04R 2499/11; H04R 9/025; H04R 1/023

(57) ABSTRACT

The present disclosure provides a sound device which includes a basket, a vibration system fixed to the basket, and a magnetic circuit system for driving the vibration system to vibrate. The vibration system includes a diaphragm fixed to the basket, and the diaphragm includes a vibration portion and a folded ring portion extending from an edge of the vibration portion, where the folded ring portion is fixed to the basket. The sound device further includes a reinforcing rib fixed to one side of the vibration portion close to the magnetic circuit system and/or one side of the vibration portion away from the magnetic circuit system. Compared with a related technology, the sound device in the present disclosure has better acoustic performance in high frequency.

### TECHNICAL FIELD

The present disclosure relates to acoustoelectric technology, and in particular, to a sound device applied to a portable electronic product.

### BACKGROUND

With an advent of a mobile Internet era, the number of smart mobile devices is increasingly rising. Among a large quantity of mobile devices, mobile phones are undoubtedly the most common and portable mobile terminal devices. A large number of sound devices for playing sounds are widely applied to the present smart mobile devices such as mobile phones.

A sound device in a related technology includes a basket, a vibration system fixed to the basket, and a magnetic circuit system for driving the vibration system to vibrate and produce sound, where the vibration system includes a diaphragm fixed to the basket. The diaphragm includes a vibration portion, and the vibration portion includes a dome portion.

However, in the related technology, the dome portion is made of aluminum foam and aluminum-sandwiched materials. As a result, structural strength of the dome portion is limited which causes cutting apart vibration or anti-phase vibration to be generated at high frequencies, resulting in a sudden drop in a SPL (Sound Pressure Level), thereby affecting acoustic performance of the sound device in high frequency.

Therefore, it is necessary to provide a new sound device to resolve the foregoing problem.

### BRIEF DESCRIPTION OF THE DRAWINGS

To describe technical solutions in embodiments of the present disclosure more clearly, the following briefly introduces accompanying drawings for describing the embodiments. Apparently, the accompanying drawings in the following description show merely some embodiments of the present disclosure, and a person of ordinary skills in the art may still derive other drawings from these accompanying drawings without creative efforts.

FIG. 1 is a schematic exploded diagram of a part of a three-dimensional structure of a sound device according to the present disclosure;

FIG. 2 is a schematic exploded diagram of a part of a three-dimensional structure for Example 1 of a vibration body portion of a sound device according to the present disclosure;

FIG. 3 is a schematic exploded diagram of a part of a three-dimensional structure for Example 2 of a vibration body portion of a sound device according to the present disclosure;

FIG. 4 is a schematic structural diagram for Example 1 of a reinforcing rib of a sound device according to the present disclosure;

FIG. 5 is a schematic structural diagram for Example 2 of a reinforcing rib of a sound device according to the present disclosure;

FIG. 6 is a schematic structural diagram for Example 3 of a reinforcing rib of a sound device according to the present disclosure; and

FIG. 7 is a schematic structural diagram for Example 4 of a reinforcing rib of a sound device according to the present disclosure.

### DETAILED DESCRIPTION

The following clearly and completely describes technical solutions in embodiments of the present disclosure with reference to accompanying drawings in the embodiments of the present disclosure. Apparently, the described embodiments are merely some embodiments rather than all the embodiments of the present disclosure. All other embodiments obtained by a person of ordinary skills in the art based on the embodiments of the present disclosure without creative efforts shall fall within the protection scope of the present disclosure.

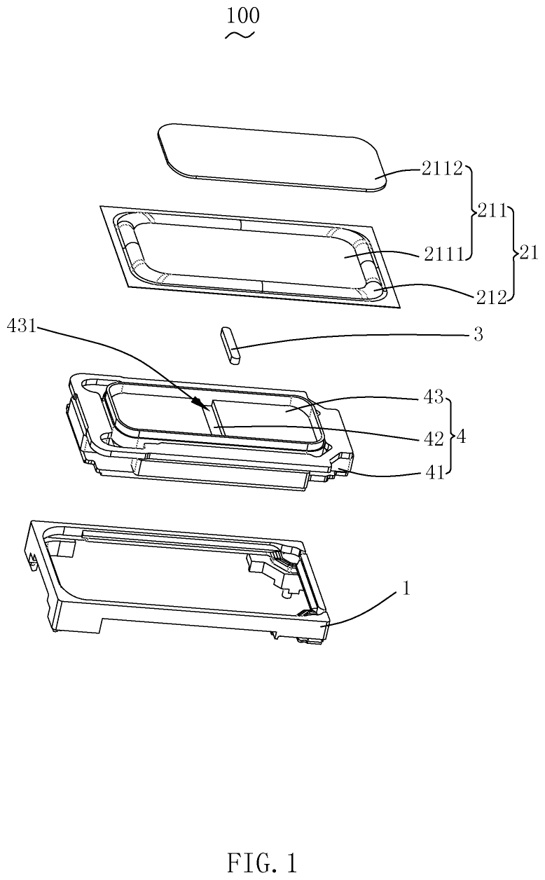

Referring to FIG. 1, the present disclosure provides a sound device 100. The sound device 100 includes a basket 1, a vibration system 2, a reinforcing rib 3, and a magnetic circuit system 4.

The basket 1 is configured to fix the vibration system 2 and the magnetic circuit system 4.

The vibration system 2 is fixed to the basket 1. The vibration system 2 includes a diaphragm 21 fixed to the basket 1. The magnetic circuit system 4 includes a magnetic bowl 41 fixed to the basket 1, a magnetic steel 42 fixed in the magnetic bowl 41, and a pole core 43 attached to one side of the magnetic steel 42 close to the diaphragm 21. The diaphragm 21 and the magnetic steel 42 are disposed parallel to each other.

The diaphragm 21 includes a vibration portion 211 and a folded ring portion 212 extending from an edge of the vibration portion 211. The folded ring portion 212 is fixed to the basket 1.

The vibration portion 211 includes a vibration body portion 2111. The following describes examples of the sound device 100 of which the vibration body portion 2111 has two different structures.

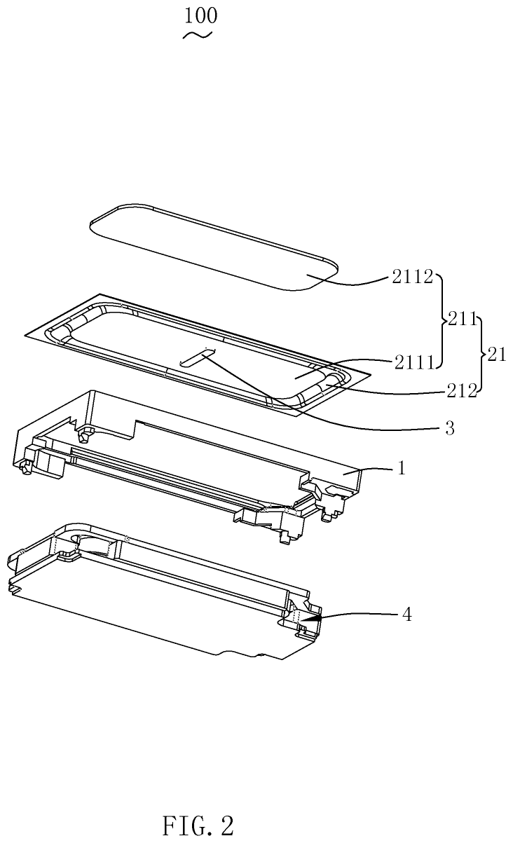

Referring to FIG. 2, in Example 1 of the sound device 100, the vibration portion 211 includes a vibration body portion 2111 and a dome 2112 covering one side of the vibration body portion 2111 away from the magnetic circuit system 4. Specifically, the reinforcing rib 3 is fixed to one side of the vibration body portion 2111 close to the magnetic circuit system 4 and/or one side of the dome 2112 away from the magnetic circuit system 4. Of course, this example is not limited thereto. The reinforcing rib 3 may be further fixed to one side of the vibration body portion 2111 away from the magnetic circuit system 4 and/or one side of the dome 2112 close to the magnetic circuit system 4. The foregoing structures can all improve stiffness of the vibration portion 211, make a SPL index in high frequency better, and improve high frequency performance of the sound device 100.

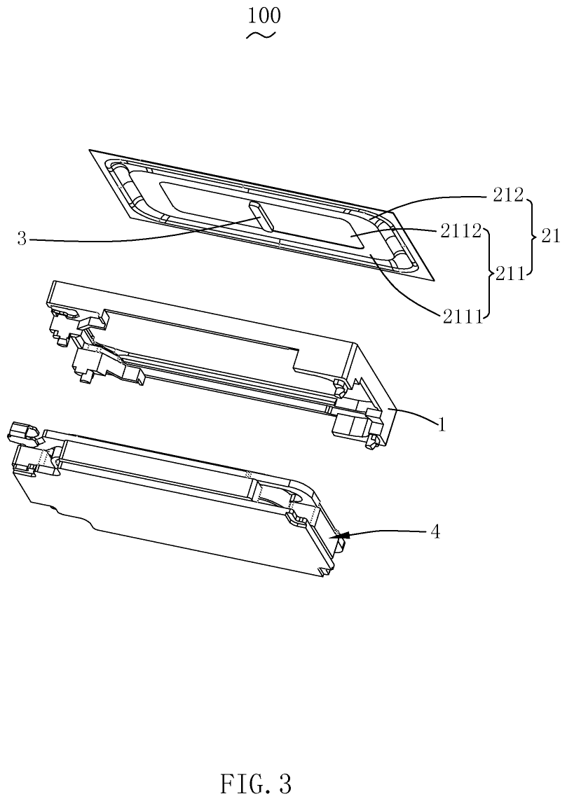

Referring to FIG. 3, in Embodiment 2 of the sound device 100, the vibration portion 211 includes a vibration body portion 2111, an opening (not shown in the figure) penetrating the vibration body portion 2111, and a dome 2112 that is fixed to the vibration body portion 2111 and that fully covers the opening. The reinforcing rib 3 is fixed to one side of the dome 2112 close to the magnetic circuit system 4 and/or one side of the dome 2112 away from the magnetic circuit system 4. In the structure, the reinforcing rib 3 is directly fixed to the dome 2112 as the opening is provided, so that stiffness of the vibration portion 211 is improved, and acoustic performance of the sound device 100 is better.

In this embodiment, the reinforcing rib 3 is fixed to the vibration portion 211 in a plurality of manners. An objective thereof is to improve stiffness of the vibration portion 211, make a SPL index in high frequency better, and improve high frequency performance of the sound device 100. There are the following four examples in which the reinforcing rib 3 is fixed to the vibration portion 211.

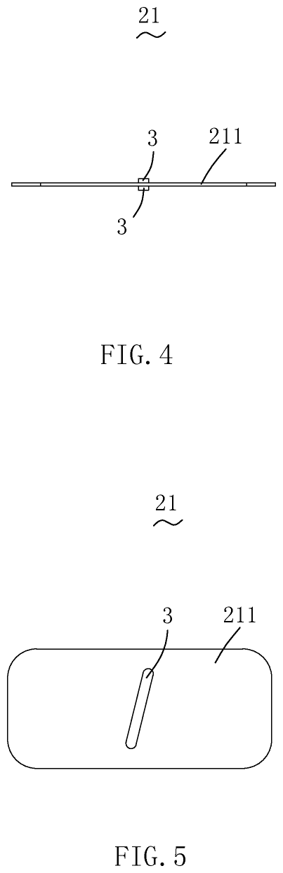

In Example 1, referring to FIG. 4, the reinforcing rib 3 is attached to one side of the dome 2112 away from the magnetic circuit system 4. Specifically, there are at least two reinforcing ribs 3. The two reinforcing ribs 3 are symmetrically fixed to two sides of the vibration portion 211 respectively. The structure of the reinforcing ribs fixed to two sides of the vibration portion 211 helps improve stiffness of the vibration portion 211 specifically and also helps improve high frequency performance.

In Example 2, at least one reinforcing rib 3 passes through a center of the vibration portion 211. The structure improves stiffness of the center of the vibration portion 211, to improve an inherent frequency of the vibration portion 211, so that a drop in the SPL occurs to a higher frequency region which human ears not sensitive to. More preferably, referring to FIG. 5, the reinforcing rib 3 is inclined to a long shaft of the diaphragm 21. The structure of the reinforcing rib 3 with an inclined angle helps improve stiffness of the vibration portion 211, not greatly increase a weight of the reinforcing rib 3, and also helps improve high frequency performance.

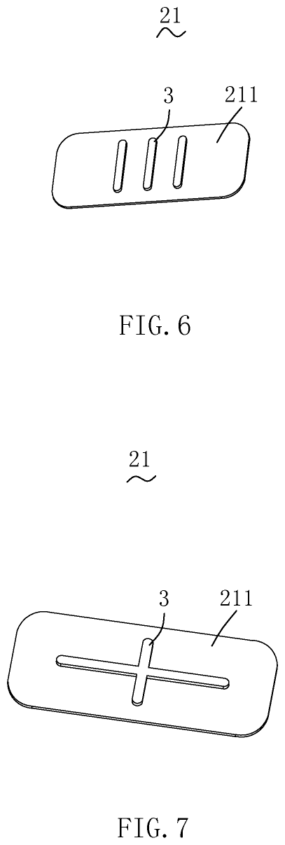

In Example 3, referring to FIG. 6, the reinforcing rib 3 is disposed parallel to a short shaft or a long shaft of the diaphragm 21. More preferably, there are at least two reinforcing ribs 3, and the at least two reinforcing ribs 3 are disposed parallel to each other. Specifically, a plurality of reinforcing ribs 3 may be disposed parallel to the short shaft or the long shaft of the basket 1. The plurality of reinforcing ribs 3 more effectively improves stiffness of the dome 2112 in a direction of the short shaft or the long shaft of the basket 1 and makes high frequency performance better.

In Example 4, referring to FIG. 7, there are at least two reinforcing ribs 3, and the at least two reinforcing ribs 3 are crossed with each other. More preferably, the sound device 100 includes two reinforcing ribs 3 that are perpendicularly crossed with each other, where one reinforcing rib 3 is disposed parallel to a short shaft of the diaphragm 21, and the other reinforcing rib 3 is disposed parallel to a long shaft of the diaphragm 21. The structure enhances stiffness of the dome 2112 in both directions of the short shaft and the long shaft of the basket 1 and provides better high frequency performance.

This embodiment is not limited thereto. The foregoing structures may be randomly combined and matched, to enhance stiffness of the dome 2112 and provide better high frequency performance.

The reinforcing rib 3 is fixed to the vibration portion 211. When the vibration portion 211 is in a state of maximum amplitude, the reinforcing rib 3 and the magnetic circuit system 4 are disposed separately from each other, that is, the reinforcing rib 3 and the magnetic steel 42 are disposed separately from each other. That is, when the magnetic circuit system 4 drives the diaphragm 21 to vibrate, the reinforcing rib 3 fixed to the vibration portion 211 also vibrates, and a thickness of the reinforcing rib 3 is needed to be considered to allow the reinforcing rib 3 not to get in contact with the magnetic circuit system 4 during vibration.

The magnetic circuit system 4 is fixed to the basket 1, and the magnetic circuit system 4 is configured to drive the vibration system 2 to vibrate. The magnetic circuit system 4 includes the magnetic bowl 41, the magnetic steel 42, and the pole core 43. The magnetic circuit system 4 is provided with a groove 431 for avoiding the reinforcing rib 3.

The magnetic bowl 41 is fixed to the basket 1.

The magnet 42 is fixedly in the magnetic bowl 41.

The pole core 43 is attached to one side of the magnetic steel 42 close to the diaphragm 21. The groove 431 is formed by a recess of the pole core 43. The reinforcing rib 3 is fixed to one side of the vibration portion 211 close to the magnetic circuit system 4, and an orthogonal projection of the reinforcing rib 3 on the pole core 43 may fully fall within the groove 431. The structure of the sound device 10 is not needed to increase a volume thereof and effectively increases the thickness of the reinforcing rib 3, thereby improving high frequency performance of the vibration portion 211. This embodiment is not limited thereto. In another structure, there are two pole cores 43 which are disposed parallel to the short shafts or the long shafts of the basket 1 to form an accommodating gap. The reinforcing rib 3 is accommodated in the accommodating gap. When the vibration portion 211 is in a state of maximum amplitude, the reinforcing rib 3 is disposed separately from the magnet 42 and the pole core 43 respectively. The structure is more easily processed, and can also improve high frequency performance of the sound device 100.

Compared with the related technology, with respect to the sound device of the present disclosure, the reinforcing rib is fixed to one side of the vibration portion close to the magnetic circuit system and/or one side of the vibration portion away from the magnetic circuit system. The structure can effectively improve stiffness of the vibration portion, thereby effectively improving acoustic performance of the sound device in high frequency.

The foregoing descriptions are merely embodiments of the present disclosure. It should be noted herein that a person of ordinary skills in the art may made improvements without departing the creation idea of the present disclosure. However, these improvements fall within the protection scope of the present disclosure.

What is claimed is:

1. A sound device, comprising a basket, a vibration system fixed to the basket, and a magnetic circuit system for driving the vibration system to vibrate, wherein the vibration system comprises a diaphragm fixed to the basket, the diaphragm comprises a vibration portion and a folded ring portion extending from an edge of the vibration portion, and the folded ring portion is fixed to the basket, wherein the sound device further comprises a reinforcing rib fixed to one side of the vibration portion close to the magnetic circuit system and/or one side of the vibration portion away from the magnetic circuit system.

2. The sound device according to claim 1, wherein the vibration portion comprises a vibration body portion and a dome covering one side of the vibration body portion away from the magnetic circuit system, and the reinforcing rib is fixed to one side of the vibration body portion close to the magnetic circuit system and/or one side of the dome away from the magnetic circuit system.

3. The sound device according to claim 1, wherein the vibration portion comprises a vibration body portion and a dome covering one side of the vibration body portion close to the magnetic circuit system, and the reinforcing rib is fixed to one side of the vibration body portion away from the magnetic circuit system and/or one side of the dome close to the magnetic circuit system.

4. The sound device according to claim 1, wherein the vibration portion comprises a vibration body portion, an opening penetrating the vibration body portion, and a dome that is fixed to the vibration body portion and that fully covers the opening, and the reinforcing rib is fixed to one side of the dome close to the magnetic circuit system and/or one side of the dome away from the magnetic circuit system.

5. The sound device according to claim 1, wherein the sound device comprises a reinforcing rib fixed to one side of the vibration portion close to the magnetic circuit system, and the magnetic circuit system is provided with a groove for avoiding the reinforcing rib.

6. The sound device according to claim 5, wherein the magnetic circuit system comprises a magnetic steel and a pole core attached to one side of the magnetic steel close to the diaphragm, and the groove is formed by a recess of the pole core.

7. The sound device according to claim 1, wherein at least one reinforcing rib passes through a center of the vibration portion.

8. The sound device according to claim 1, wherein the reinforcing rib is disposed parallel to a short shaft or a long shaft of the diaphragm.

9. The sound device according to claim 1, wherein there are at least two reinforcing ribs, and the at least two reinforcing ribs are disposed parallel to each other.

10. The sound device according to claim 1, wherein the reinforcing rib is inclined to a long shaft of the diaphragm.

11. The sound device according to claim 1, wherein there are at least two reinforcing ribs, and the at least two reinforcing ribs are crossed with each other.

12. The sound device according to claim 11, wherein the sound device comprises two reinforcing ribs that are perpendicularly crossed with each other, one reinforcing rib is disposed parallel to a short shaft of the diaphragm, and the other reinforcing rib is disposed parallel to a long shaft of the diaphragm.
